(19) United States
(12) Patent Application Publication
(10) Pub. No.: US 2016/0144871 A1
(43) Pub. Date: May 26, 2016

(54) Inverter-Based Head End Power System

(71) Applicant: Electro-Motive Diesel, Inc., LaGrange, IL (US)

(72) Inventor: Madan Jalla, Woodridge, IL (US)

(73) Assignee: ELECTRO-MOTIVE DIESEL, INC., LaGrange, IL (US)

(21) Appl. No.: 14/553,689

(22) Filed: Nov. 25, 2014

(51) Int. Cl. B61C 7/00; B60L 1/00

(52) U.S. Cl. CPC B61C 7/00; B60L 1/00

(57) ABSTRACT

A head end power (HEP) system for a locomotive is disclosed. The HEP system may include a first HEP inverter module operatively connected between a direct current (DC) link and a transformer, and a second HEP inverter module operatively connected between the DC link and the transformer in parallel with the first HEP inverter module. The first HEP inverter module and the second HEP inverter module may be configured to convert power from the DC link into an alternating current (AC). The transformer may be configured to transfer power from the first HEP inverter module and the second HEP inverter module to a HEP bus.

### FIELD OF THE DISCLOSURE

The present disclosure relates generally to locomotives and, more particularly, head end power systems for locomotives.

### BACKGROUND OF THE DISCLOSURE

Freight trains and passenger trains generally include a locomotive that provides the motive power for a train. Having no payload capacity of its own, the sole purpose of the locomotive is to move the train along the tracks. Typically, the locomotive may use an engine to drive a primary power source, such as, a main generator or an alternator. Converting mechanical energy into electrical energy, the primary power source provides power to traction motors in order to drive wheels of the locomotive. The traction motors propel the train along the tracks.

Unlike freight cars, passenger cars of a train require electrical power for various applications unrelated to propulsion or locomotion. For example, passenger cars may require electrical power for heating, cooling, ambient lighting, and energizing electrical outlets. To provide electrical power for passenger cars, locomotives of passenger trains also include a head end power (HEP) system.

A head end power (HEP) system is the electrical power distribution system on a passenger train. Typically, HEP systems include a HEP generator, which is a separate generator in addition to the primary power source of the locomotive. The HEP generator may either be a parasitic generator driven by the engine of the locomotive or a smaller engine/generator that operates independently of the main locomotive engine.

If the HEP generator is a parasitic generator, the main engine of the locomotive may have to maintain a higher power output and fuel consumption. If the HEP generator operates independently of the main engine, then the use of a separate system may translate into higher maintenance costs. In addition, both types of HEP generators produce undesirable noise levels and require additional fuel consumption, which leads to increased emissions.

A system and a method for controlling multiple inverter-driven loads are disclosed in U.S. Patent Application Publication No. 2014/0139016A1, entitled, “System for Multiple Inverter-Driven Loads.” The 2014/0139016 publication describes a vehicle having a first alternator that powers a traction bus and a second alternator that powers a HEP circuit. The vehicle further includes an inverter coupled to the second alternator, and a plurality of loads coupled to the inverter. While effective, the 2014/0139016 vehicle still requires a second alternator to supply HEP. Improvements in HEP systems are desired to reduce noise levels, fuel consumption, and emission levels.

### SUMMARY OF THE DISCLOSURE

In accordance with one embodiment, a head end power (HEP) system for a locomotive is disclosed. The HEP system may include a first HEP inverter module operatively connected between a direct current (DC) link and a transformer, and a second HEP inverter module operatively connected between the DC link and the transformer in parallel with the first HEP inverter module. The first HEP inverter module and the second HEP inverter module may be configured to convert power from the DC link into an alternating current (AC). The transformer may be configured to transfer power from the first HEP inverter module and the second HEP inverter module to a HEP bus.

In accordance with another embodiment, a locomotive is disclosed. The locomotive may include a power source, a traction system operatively connected to the power source and configured to move the locomotive, an auxiliary power locomotive (APL) system operatively connected to the power source and configured to provide power to auxiliary loads of the locomotive, and a head end power (HEP) system operatively connected to the power source and configured to provide power through a HEP bus to passenger cars of the locomotive. The HEP system may include a transformer including a first primary winding and a second primary winding, the transformer configured to transfer power to the HEP bus; a first HEP inverter module operatively connected between a direct current (DC) link and the first primary winding of the transformer; and a second HEP inverter module operatively connected between the DC link and the second primary winding of the transformer, the second HEP inverter module in parallel with the first HEP inverter module, the first HEP inverter module and the second HEP inverter module configured to convert power from the DC link into an alternating current (AC) for the HEP bus.

In accordance with yet another embodiment, a method for providing head end power (HEP) in a locomotive is disclosed. The method may include distributing a HEP load over a first HEP inverter module and a second HEP inverter module in parallel between a direct current (DC) link and a transformer.

These and other aspects and features will become more readily apparent upon reading the following detailed description when taken in conjunction with the accompanying drawings. In addition, although various features are disclosed in relation to specific exemplary embodiments, it is understood that the various features may be combined with each other, or used alone, with any of the various exemplary embodiments without departing from the scope of the disclosure.

### BRIEF DESCRIPTION OF THE DRAWINGS

FIG. 1 is a diagrammatic view of vehicle, in accordance with one embodiment of the present disclosure;

FIGS. 2.1-2.3 are a diagrammatic view of a power system for the vehicle of FIG. 1;

FIG. 3 is a diagrammatic view of a head end power (HEP) system for the vehicle of FIG. 1;

FIG. 4 is a schematic representation of the HEP system of FIG. 3;

FIG. 5 is a diagrammatic view of a control system for the HEP system of FIG. 3;

FIG. 6 is a schematic representation of the control system of FIG. 5;

FIG. 7 is a graph of output voltage and current waveforms of a HEP transformer of the HEP system in FIG. 3;

FIG. 8 is a graph of a generated control waveform for the control system of FIG. 5;

FIG. 9 is a graph of operating regions for sine-triangle pulse width modulation (PWM) in nine pulse mode, in accordance with another embodiment;

FIG. 10 is a graph of operation regions for sine-triangle PWM with third order harmonic injection in nine pulse mode for the control system of FIG. 5, in accordance with another embodiment;

FIG. 11 is a graph of simulation results illustrating a relation between voltage total harmonic distortion and carrier waveform phase shifting for the control system of FIG. 5;

FIG. 12 is a schematic representation of a primary mode of the HEP system of FIG. 3;

FIG. 13 is a schematic representation of a back-up mode of the HEP system of FIGS. 3; and

FIG. 14 is a flowchart illustrating a process for providing head end power (HEP) in a locomotive, in accordance with yet another embodiment.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

The present disclosure provides an inverter-based system and method for providing head end power (HEP) in a locomotive. The HEP system and method provide at least two inverter modules in parallel between a direct current (DC) link and a transformer. The transformer of the HEP system and method allows the inverter modules to be paralleled, while generating a single output onto a HEP bus. The HEP bus then delivers the necessary power to the various loads of the HEP system. Furthermore, the DC link input to the parallel inverter modules is supplied by the primary power source, or main alternator/generator. In so doing, a separate HEP generator is not needed for the disclosed system and method. By eliminating a second generator, the inverter-based HEP system and method significantly reduce noise levels, fuel consumption, and emission levels in locomotives, while still providing the requisite HEP to passenger train cars,

Reference will now be made in detail to specific embodiments or features, examples of which are illustrated in the accompanying drawings. Generally, corresponding reference numbers will be used throughout the drawings to refer to the same or corresponding parts.

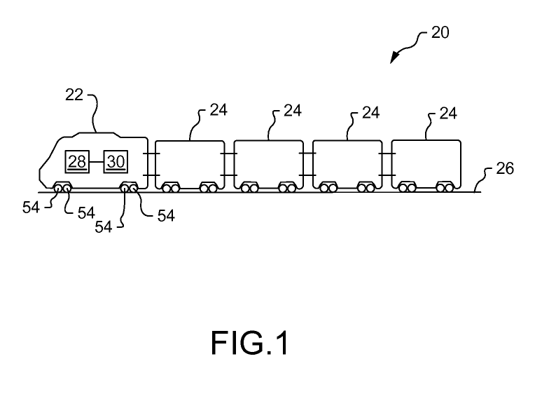

FIG. 1 illustrates a vehicle 20 consistent with certain embodiments of the present disclosure. Although vehicle 20 is illustrated as a rail transport vehicle, the vehicle 20 may be any type of vehicle or machine used to perform a driven operation involving physical movement associated with a particular industry, such as, without limitation, transportation, mining, construction, landscaping, forestry, agriculture, etc.

Non-limiting examples of vehicles and machines, for both commercial and industrial purposes, include trains, diesel-electric locomotives, diesel mechanical locomotives, mining vehicles, on-highway vehicles, earth-moving vehicles, loaders, excavators, dozers, motor graders, tractors, trucks, backhoes, agricultural equipment, material handling equipment, marine vessels, and other types that operate in a work environment. It is to be understood that the vehicle 20 is shown primarily for illustrative purposes to assist in disclosing features of various embodiments, and that FIG. 1 does not depict all of the components of a vehicle.

The vehicle 20 may include a locomotive 22 coupled to at least one railcar 24. The vehicle 20 may travel along a route 26, such as, one or more rails of a track. Railcars 24 may be passenger cars or freight cars for carrying passengers, goods, or other loads. The locomotive 22 may include an engine 28, or other power source, and a power system 30. The engine 28 may be electric, diesel, steam, hydrogen, gas turbine powered, hybrid, or of any other type for generating energy to propel the vehicle 20. Power system 30 may be configured to distribute electrical power to propulsion and non-propulsion electric loads.

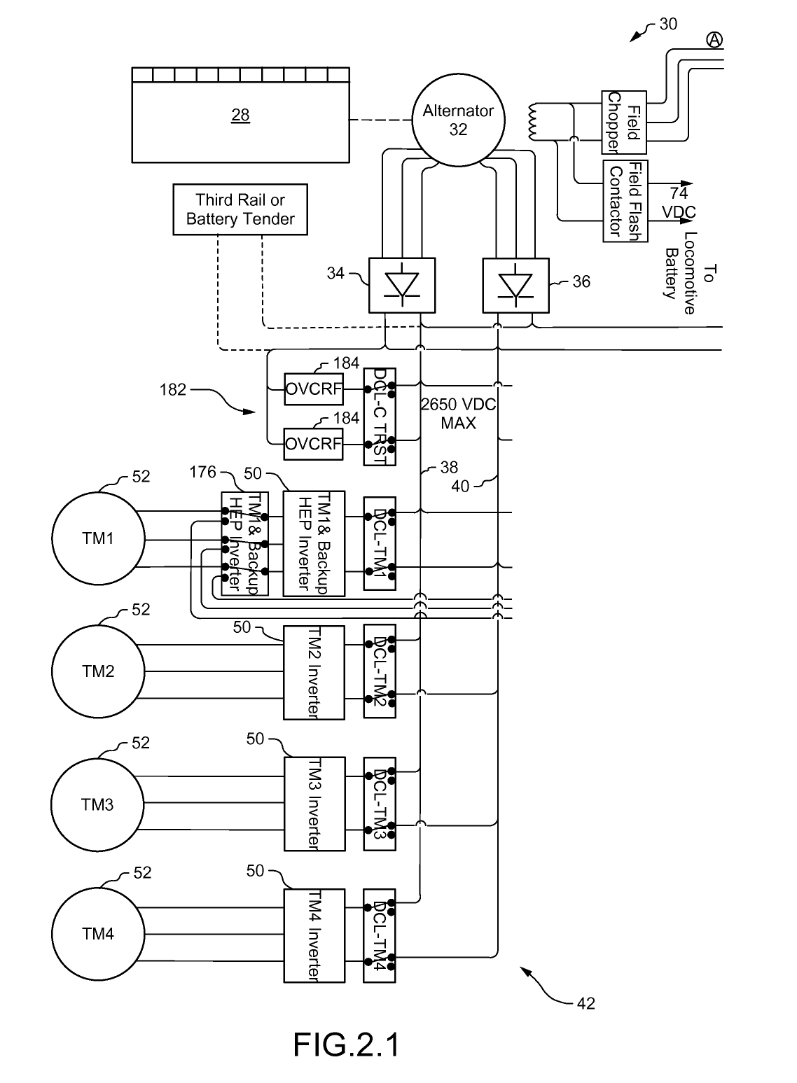

Referring now to FIGS. 2.1-2.3, with continued reference to FIG. 1, a diagrammatic view of the power system 30 is shown, in accordance with an embodiment of the present disclosure. The power system 30 may include an alternator 32 operatively coupled to the engine 28. The alternator 32 may convert mechanical energy generated by the engine 28 into electrical energy in the form of alternating current (AC). However, other types of generators than alternator 32 may be used. At the output of the alternator 32, a first rectifier 34 and a second rectifier 36 may convert AC to direct current (DC) that is conveyed on a first DC link 38 and a second DC link 40, respectively. In one example, the alternator 32 may be configured to provide a minimum voltage of 2000 V on each of the first DC link 38 and the second DC link 40, based on a rotational speed of 1000 rpm of the engine 28. However, other configurations may certainly be used.

The power system 30 may further include a traction system 42, an auxiliary power locomotive (APL) system 44, a dynamic braking (DB) grid chopper system 46, and a head end power (HEP) system 48. The fraction system 42 may be configured to move the locomotive 22 and propel the vehicle 20 along the route 26. For example, the first DC link 38 may convey DC to the traction system 42. The traction system 42 may include traction inverter modules 50 to convert DC into AC for traction motors 52 configured to drive wheels 54 (FIG. 1) of the locomotive 22. Although, in FIG. 2.1, the traction system 42 includes four traction inverter modules 50 and four fraction motors 52, one traction inverter module 50 per individual traction motor 52, it is to be understood that other configurations are certainly possible.

The APL system 44 may be configured to provide power to auxiliary loads 56 on the locomotive 22. Non-limiting examples of on-locomotive auxiliary loads 56 may include blowers, cooling fans, compressors, pumps, power outlet systems, and various other loads. An APL inverter module 58 may convert DC from the second DC link 40 into AC, which is then filtered through an APL filter 60 and transferred by an APL transformer 62 to various components 64 of the APL system 44. The APL system 44 may include components 64, such as, one or more rectifiers, auxiliary inverters, contactors, transformers, auxiliary power converters, and the like, configured to convey power from the APL transformer 62 in an acceptable form to each of the auxiliary loads 56 or protect the auxiliary loads 56. It is to be understood that APL system 44 is not limited to the loads 56 and components 64 shown, in FIG. 2.3, and that other configurations are certainly possible.

Operatively connected to the traction system 42, the APL system 44, and the HEP system 48, the DB grid chopper system 46 may be configured to provide power for use by the APL system 44 and the HEP system 48 through dynamic braking of the traction motors 52 in the traction system 42. When the locomotive 22 is in a DB mode, the traction motors 52 may be used as generators when slowing the locomotive 22. A DB grid chopper 66 may control an amount of energy that is dissipated into brake grid resistors 68 and an amount of energy that is supplied into the APL and HEP systems 44, 48. A grid blower 70, as well as other components, may also be included in the DB grid chopper system 46.

The HEP system 48 may be configured to provide power to the railcars 24 of the vehicle 20. For example, the HEP system 48 may be a distribution network for 480 V 60 Hz passenger train line loads, although the HEP system 48 may also be configured to meet other requirements. More specifically, passenger cars may use HEP for heating, cooling, ambient lighting, energizing electrical outlets, and other purposes. While the APL system 44 provides power to non-propulsion electric loads on the locomotive, the HEP system 48 may provide power to non-propulsion electric loads in the railcars 24. Receiving DC from the second DC link 40, the HEP system 48 may include at least two HEP inverter modules 72, 74 in parallel, at least two HEP filter modules 84,86 and a HEP transformer 78. Connected to the output of the HEP transformer 78, a HEP bus 80 may deliver power to loads 82 of the HEP system 48. Although FIG. 2.2 illustrates the HEP loads 82 as left and right HEP rear loads, left and right HEP front loads, a coolant heater, and a coolant pump, there may be other types of HEP loads in the railcars 24.

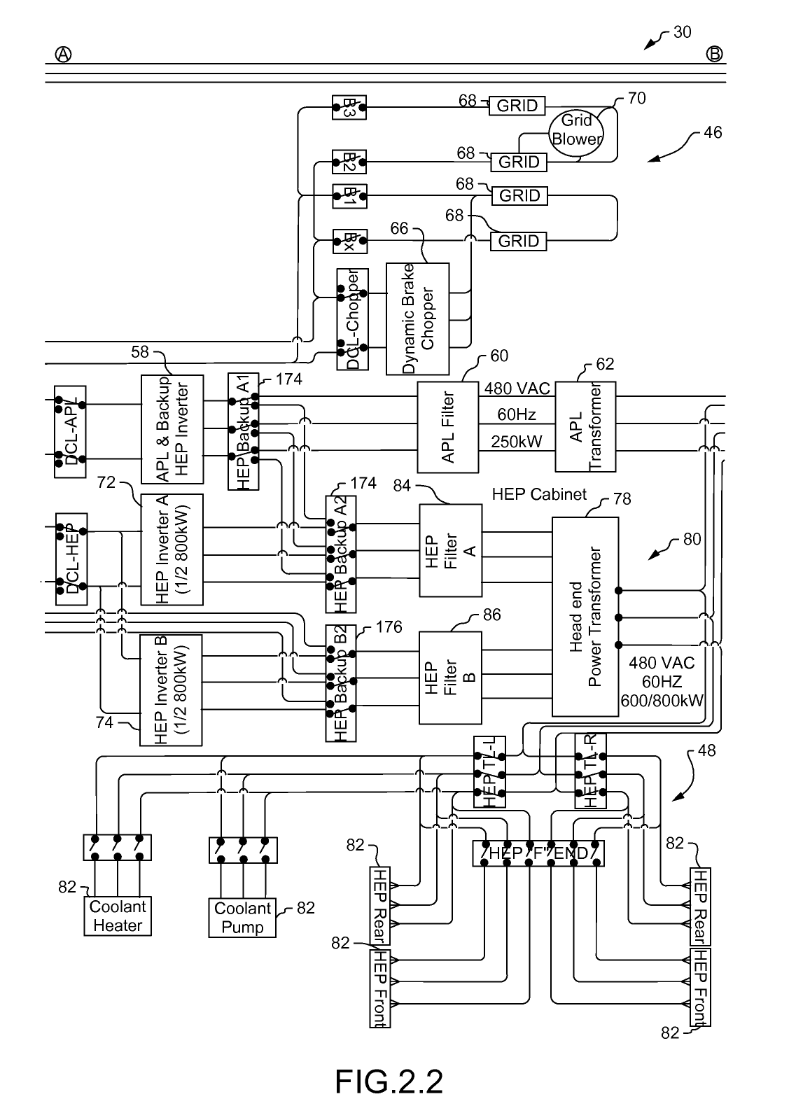

As shown in FIG. 3, with continued reference to FIGS. 1 and 2, the HEP system 48 may include a first HEP inverter module 72 operatively connected between the second DC link 40 and the HEP transformer 78, and a second HEP inverter module 74 operatively connected between the second DC link 40 and the HEP transformer 78. The second HEP inverter module 74 may be in parallel with the first HEP inverter 72 in order to distribute the HEP loads 82 between the first and second HEP inverter modules 72, 74. Each of the first and second HEP inverter modules 72, 74 may be configured to convert power from the second DC link 40 into AC.

In addition, the HEP system 48 may include a first line filter module 84 and a second line filter module 86. The first line filter module 84 may be operatively connected between an output 88 of the first HEP inverter module 72 and an input 90 of the HEP transformer 78, while the second line filter module 86 may be operatively connected between an output 92 of the second HEP inverter module 74 and an input 94 of the HEP transformer 78. Each of the first line filter module 84 and the second line filter module 86 may be configured to reduce harmonic content on the output 88 of the first HEP inverter module 72 and the output 92 of the second HEP inverter module 74, respectively.

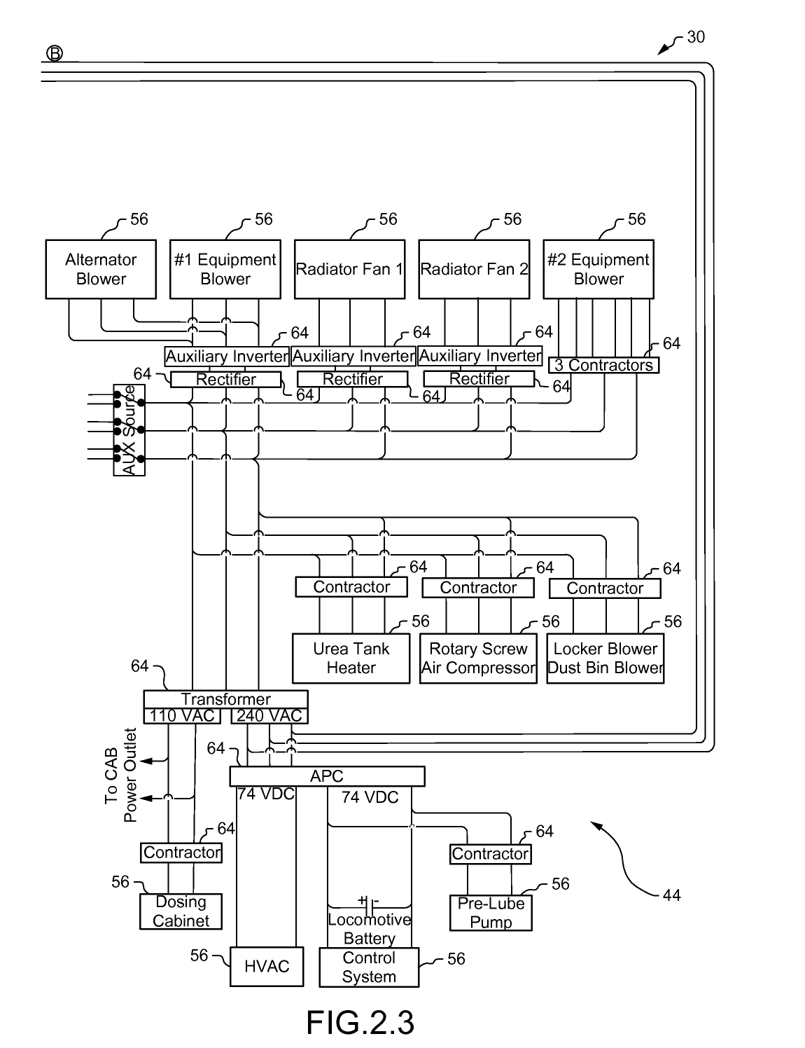

Turning now to FIG. 4, with continued reference to FIGS. 1-3, each of the HEP inverter modules 72, 74 may comprise a three-phase inverter including a plurality of insulated gate bipolar transistors (IGBTs) and a plurality of diodes. However, other configurations for the HEP inverter modules 72, 74 may be used. Each of the line filter modules 84, 86 may comprise an inductor-capacitor (LC) filter including a three-phase inductor assembly 96 and a three-phase capacitor assembly 98, although other configurations may be used.

The HEP transformer 78 may comprise a dual primary winding delta-delta-wye three-phase transformer. For example, the HEP transformer 78 may include a first primary winding 100, a second primary winding 102, and a secondary winding 104. The output 88 of the first HEP inverter module 72 may be operatively connected to the first primary winding 100 of the HEP transformer 78, while the output 92 of the second HEP inverter module 74 may be operatively connected to the second primary winding 102 of the HEP transformer 78. The secondary winding 104 or single output of the transformer 78 may be connected to the HEP bus 80, which conveys power to the loads 82 of the railcars 24. For instance, the HEP system 48 and output on the HEP bus 80 may be designed to meet American Public Transportation Association (APTA) standards. However, the HEP system 48 and output on the HEP bus 80 may be designed to meet other standards as well.

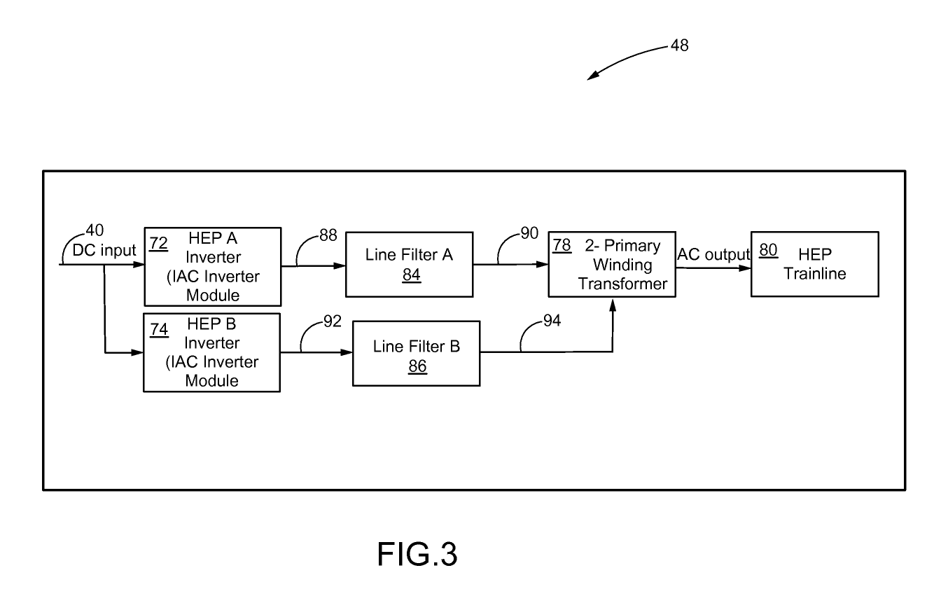

Referring now to FIG. 5, with continued reference to FIGS. 1-4, a diagrammatic view of a control system 106 for the HEP system 48 and power system 30 of the locomotive 22 is shown, according to an embodiment of the present disclosure. The control system 106 may be implemented using one or more of a processor, a microprocessor, a microcontroller, a digital signal processor (DSP), a field-programmable gate array (FGPA), an electronic control module (ECM), an electronic control unit (ECU), and a processor-based device that may include or be associated with a non-transitory computer readable storage medium having stored thereon computer-executable instructions, or any other suitable means for electronically controlling functionality of the locomotive 22. Other hardware, software, firmware, or combinations thereof may be included in the control system 106. In addition, the control system 106 may be configured to operate according to predetermined algorithms or sets of instructions programmed or incorporated into memory that is associated with or at least accessible to the control system 106.

For example, the control system 106 may comprise a locomotive control computer (LCC) 108 in communication with an operator interface 110 and at least one HEP inverter controller 112, 114. In one embodiment, the LCC 108 may comprise an Electro-Motive EM2000 device, although other devices for the LCC 108 may be used. The operator interface 110 may be configured to receive input from and output data to an operator of the locomotive 22. For example, the operator interface 110 may include a Functionality Integrated Railroad Electronics (FIRE) display 116. However other operator controls may be included in the operator interface 110, such as, without limitation, one or more pedals, joysticks, buttons, switches, dials, levers, steering wheels, keyboards, touchscreens, displays, monitors, screens, lights, speakers, horns, sirens, buzzers, voice recognition software, microphones, control panels, instrument panels, gauges, etc.

In communication with the LCC 108 and the first HEP inverter module 72, a first HEP inverter controller 112 may perform control and protection functions related to the first HEP inverter module 72. In communication with the LCC 108 and the second HEP inverter module 74, a second HEP inverter controller 114 may perform control and protection functions related to the second HEP inverter module 74. Furthermore, the first HEP inverter controller 112 and the second HEP inverter controller 114 may be in communication with each other. Each of the first HEP inverter controller 112 and the second HEP inverter controller 114 may be configured to read sensor inputs, receive and send signals to and from the LCC 108, and receive and send signals to each other. For example, each of the HEP inverter controllers 112, 114 may comprise an A4P1 device or an A5P1 device, although other devices may be used.

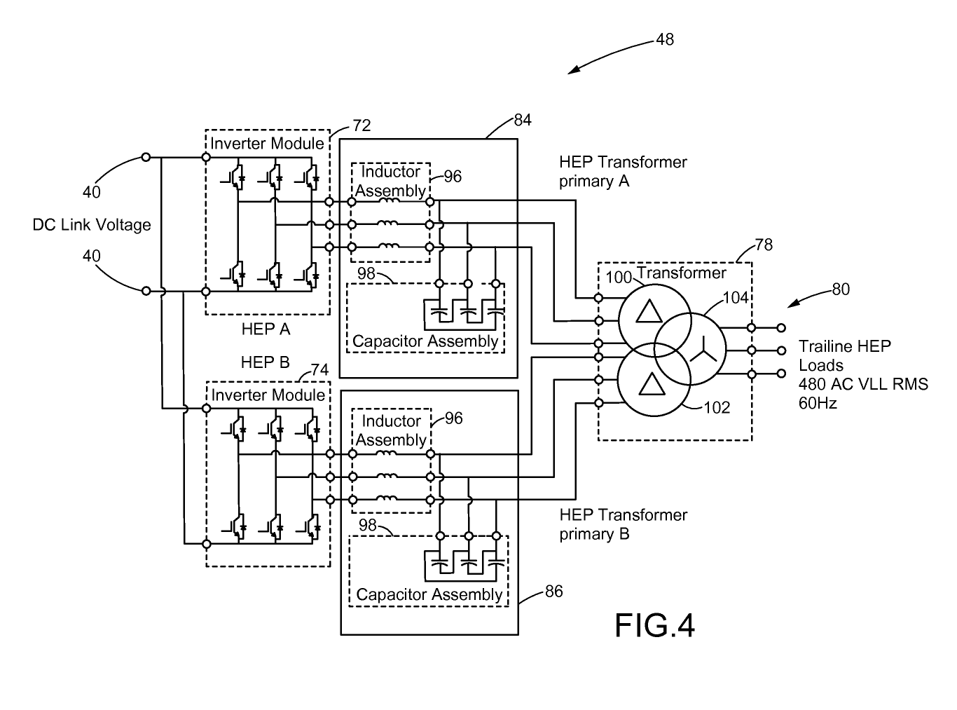

Turning now to FIG. 6, with continued reference to FIGS. 1-5, a functional block diagram of the control system 106 is shown, according to an embodiment of the present disclosure. With the first HEP inverter module 72 and the second HEP inverter module 74 in parallel, the control system 106 may synchronize the second HEP inverter module 74 to the first HEP inverter module 72 (or vice versa). For example, the control system 106 may be configured to synchronize the first and second HEP inverter modules 72, 74 using phase lock loop (PLL).

More specifically, on the output 88 of the first HEP inverter module 72, sensors 118 may measure a current in each individual phase and send corresponding signals Iu_invA, Iv_invA, Iw_invA to the first HEP inverter controller 112. On an output 120 of the first line filter module 84, sensors 118 may measure a current and voltage in each individual phase and send corresponding signals IuA, IvA, IwA, V_{c}uA, V_{c}wA to the first HEP inverter controller 112. In addition, on an output 122 of the HEP transformer 78, sensors 118 may measure a voltage in each individual phase and send corresponding signals Vu, Vw to the first HEP inverter controller 112. The measured output voltage Vu, Vw of the HEP transformer 78 may then be displayed to the operator using the operator interface 110, such as, on the FIRE display 116.

Receiving the measured current on the output 88 of the first HEP inverter module 72, an ABC/DQ transformation module 124 of the first HEP inverter controller 112 may convert the three-phase signals Iu_invA, Iv_invA, Iw_invA into two-phase signals Id_invA, Iq_invA. Similarly, two ABC/DQ transformation modules 124 may convert the three-phase signals of the measured current and voltage IuA, IvA, IwA, V_{c}uA, V_{c}wA on the output 120 of the first line filter module 84 into two-phase signals IdA, IqA, V_{c}dA, V_{c}qA. In addition, the three-phase signals Vu, Vw of the measured voltage on the output 122 of the HEP transformer 78 may be converted into two-phase signals Vd, Vq by another ABC/DQ transformation module 124.

Output voltage control module 126 may compare the two-phase signals Vd, Vq of the voltage on the output 122 of the HEP transformer 78 to reference voltage input signals Vd*, Vq*. For instance, a reference voltage may be 480 V, although other voltages are certainly possible. The output voltage control module 126 sends signals V_{c}dA*, V_{c}qA* indicative of an error between the measured voltage Vd, Vq and the reference voltage Vd*, Vq* to a voltage control module 128.

The voltage control module 128 may compare the error signals V_{c}dA*, V_{c}qA* with the voltage signals V_{c}dA, V_{c}qA on the output 120 of the first line filter module 84, or a primary side 130 of the HEP transformer 78. Based on that comparison, the voltage control module 128 generates and sends current reference signals IdA*, IqA* to a current control module 132. The current control module 132 compares the output current signals Id_invA, Iq_invA of the first HEP inverter module 72, the output current signals IdA, IqA of the first line filter module 84, and the current reference signals IdA*, IqA*.

Based on the comparison of all the current input signals, the current control module 132 generates and sends a voltage command signal 134 to a pulse width modulation (PWM) module 136. Based on the voltage command signal 134, the PWM module 136 generates a PWM signal 138 used to control the first HEP inverter module 72. For example, the PWM signal 138 may be indicative of a modulation ratio and phase angle at which the first HEP inverter module 72 should be operated.

The second HEP inverter controller 114 may be configured to control the second HEP inverter module 74 in a similar manner as the first HEP inverter controller 112 is configured to control the first HEP inverter module 72. Sensors 118 and ABC/DQ transformation modules 124 associated with the second HEP inverter controller 114 perform the same functions as those associated with the first HEP inverter controller 112, except as applied to the second HEP inverter module 74 and the second line filter 86.

In order to synchronize the second HEP inverter module 74 with the first HEP inverter module 72, the first HEP inverter controller 112 may calculate a HEP of the first HEP inverter module 72. Based on the measured current signals IdA, IqA and the measured voltage signals V_{c}dA, V_{c}qA on the primary side 130 of the HEP transformer 78, a first HEP power calculation module 140 generates power signals P_{A}, Q_{A} indicative of real and reactive power for the first HEP inverter module 72. The first HEP inverter controller 112 may send power signals P_{A}, Q_{A} to the second HEP inverter controller 114.

Sensors 118 may be used to measure voltage on an output 142 of the second line filter module 86, or input 94 of the second primary winding 102 (FIG. 4) of the HEP transformer 78, and generate signals V_{c}uB, V_{c}wB. Similar to the first HEP power calculation module 140, a second HEP power calculation module 144 may calculate a HEP of the second HEP inverter module 74 based on two-phase output voltage signals V_{c}dB, V_{c}qB and current signals IdB, IqB of the second line filter module 86. The second HEP power calculation module 144 may then generate power signals P_{B}, Q_{B} indicative of real and reactive power for the second HEP inverter module 74.

Using the power signals P_{A}, Q_{A} from the first HEP inverter controller 112 as reference signals P_{B}*, Q_{B}*, the second HEP inverter controller 114 may be configured to track the first HEP inverter module 72 and match the second HEP inverter module 74 to the first HEP inverter module 72. In so doing, the second HEP inverter module 74 may lock in phase with the first HEP inverter module 72 so that they are synchronized. Furthermore, the output 122 of the HEP transformer 78 may be shared between the first HEP inverter module 72 and the second HEP inverter module 74 using PLL.

More specifically, a real and reactive power control module 146 may compare reference signals P_{B}*, Q_{B}* indicative of real and reactive power for the first HEP inverter module 72 with the real and reactive power signals P_{B}, Q_{B} for the second HEP inverter module 74. Similar to the output voltage control module 126, the real and reactive power control module 146 may then calculate an error between the signals P_{B}*, Q_{B}* and P_{B}, Q_{B} and send corresponding signals V_{c}dB*, V_{c}qB* indicative of the error to the voltage control module 128. The voltage control module 128, the current control module 132, and the PWM module 136 associated with the second HEP inverter controller 114 perform the same functions as those associated with the first HEP inverter controller 112, except as applied to the second HEP inverter module 74 and the second line filter 86, while using signals V_{c}dB*, V_{c}qB* as reference voltage signals.

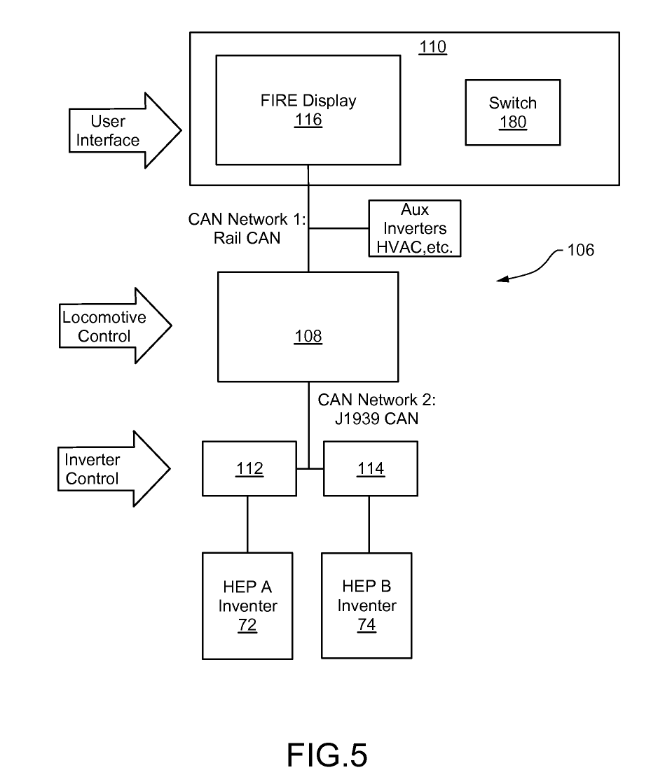

Moreover, by measuring the output voltage of the HEP transformer 78 and providing voltage feedback, the control system 106 may adjust modulation ratios of the first HEP inverter module 72 and the second HEP inverter module 74 in order to maintain a constant voltage output. For example, the voltage output may be maintained at 480 Vac LL rms although other values may certainly be possible. The control system 106 may also compensate for IGBT voltage drops, filter voltage drops, and voltage regulation of the HEP transformer. Examples of an output line-to-line voltage waveform 148 and an output current waveform 150 of the HEP system 48 are shown in FIG. 7. However, voltage and current waveforms are certainly possible.

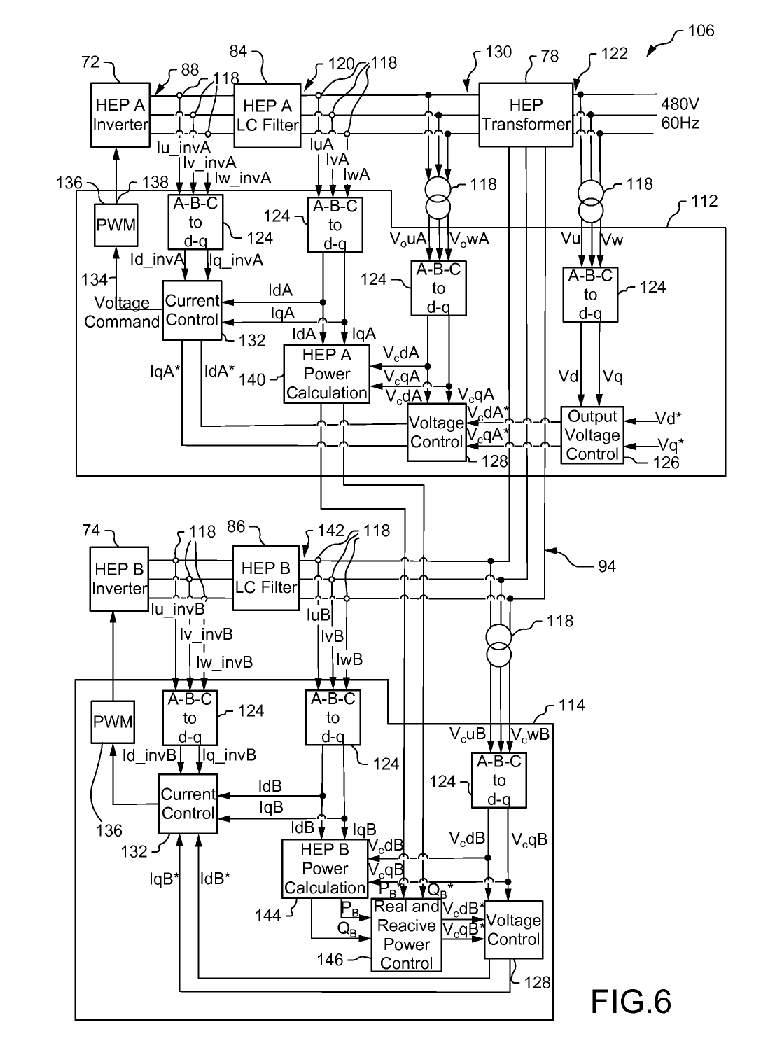

Furthermore, the control system 106 may be configured to implement sine-triangle PWM with a third order harmonic injection when controlling the first HEP inverter module 72 and the second HEP inverter module 74, such as in PWM modules 136. As shown in FIG. 8, a control waveform 152 may be generated as a sum of a sinusoidal waveform 154 with a third order harmonic injection at fundamental frequency and a triangular carrier waveform 156 at switching frequency. For instance, the switching frequency may be a constant frequency operating in nine pulse mode. In one example, the fundamental frequency may be 60 Hz making the switching frequency 540 Hz in nine pulse mode. However, other frequencies and modes may be used.

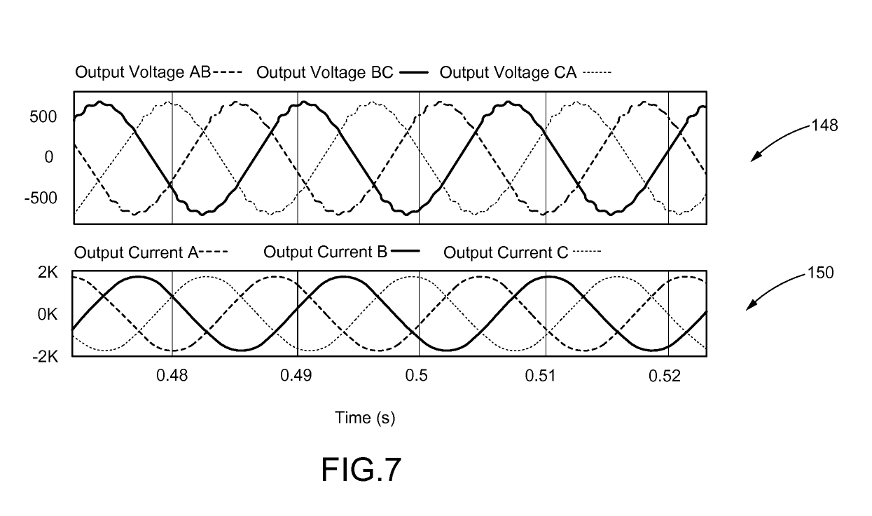

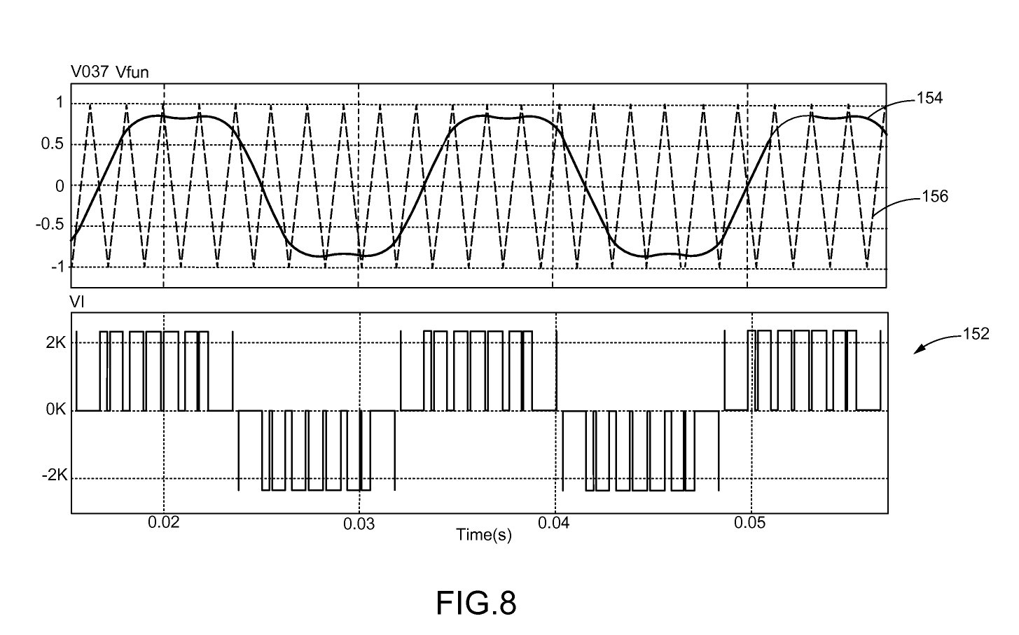

An example 158 of operating regions for sine-triangle PWM in nine pulse mode is shown in FIG. 9. In this example, a linear region 160 may end at a modulation index of 1, and above the modulation index of 1, an over-modulation region 162 may begin. In the over-modulation region 162, output voltage total harmonic distortion may increase. An example 164 of operating regions for sine-triangle PWM with third order harmonic injection in nine pulse mode is shown in FIG. 10. In this example, a linear region 166 may end at a modulation index of 1.15, and an over-modulation region 168 may begin above the modulation index of 1.15. In so doing, third order harmonic injection may provide 15% more margin to operate in the linear region 166, compared to the linear region 160 in the example 158 of FIG. 9, which does not include third order harmonic injection.

Third order harmonic injection allows the first and second HEP inverter modules 72, 74 to generate a higher three-phase output voltage at a given DC link voltage, when compared to a conventional sinusoidal fundamental waveform. As illustrated through the examples 158, 160 in FIGS. 9 and 10, with third order harmonic injection, the controller can operate in an extended linear region. As a result, total harmonic distortion of the HEP system 48 output voltage may be significantly limited, such as, to below 5% during steady state operation.

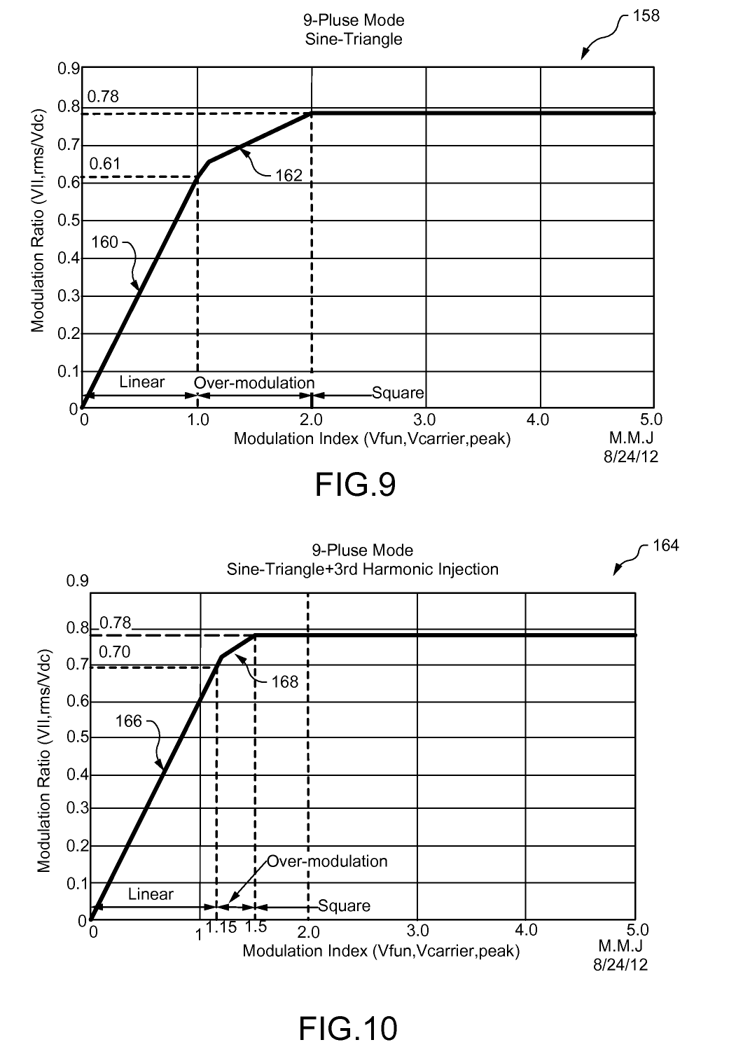

To further reduce harmonics, as well as a size of the LC filters in the first and second line filter modules 84, 86, the control system 106 may interleave carrier waveforms on the first and second HEP inverter modules 72, 74 and implement a carrier phase shift. Phase shifting a carrier waveform of the second HEP inverter module 74 may cancel harmonics generated by the first HEP inverter module 72 (or vice versa). In one example, in the PWM module 136 associated with the second HEP inverter controller 114, the carrier waveform for the second HEP inverter module 74 may be phase shifted by 180 degrees. As shown in FIG. 11, simulation results have indicated that the total harmonic distortion of the HEP system 48 output voltage is lowest when the carrier waveforms on the first and second HEP inverter modules 72, 74 are shifted by 180 degrees.

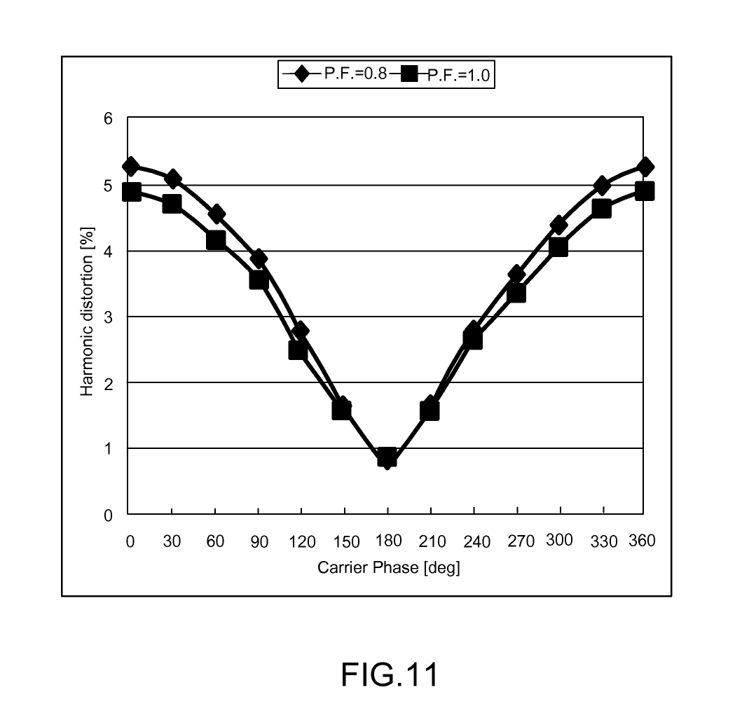

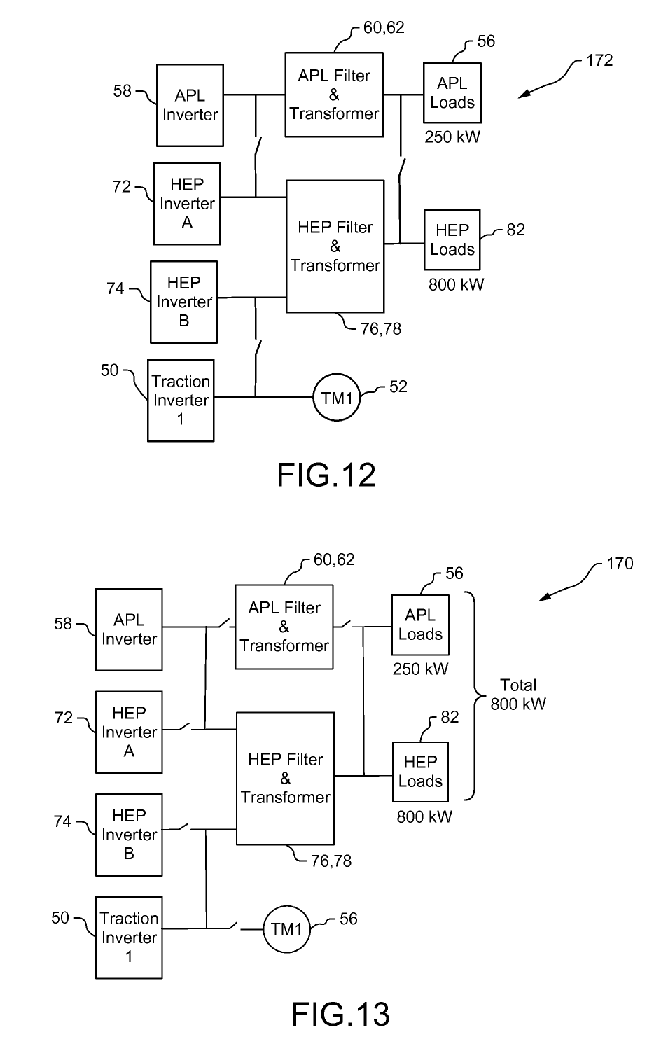

Turning now to FIGS. 12 and 13, with continued reference to FIGS. 1-11, the HEP system 48 may include a back-up mode 170 in case one of the first and second HEP inverter modules 72, 74 fails. In particular, the APL inverter module 58 and one of the traction inverter modules 50 may be selectively paralleled with the first and second HEP inverter modules 72, 74 to provide back-up HEP. As shown in FIG. 12, in a primary mode 172 of the HEP system 48, the first and second HEP inverter modules 72, 74 provide HEP to the HEP loads 82. As shown in FIG. 13, in back-up mode 170, the APL inverter module 58 and one traction inverter module 50 provide HEP to the HEP loads 82.

When either one of the first HEP inverter module 72 or the second HEP inverter module 74 fails, the APL inverter module 58 may take the place of the first HEP inverter module 72, and the traction inverter module 50 may take the place of the second HEP inverter module 74 in back-up mode 170. However, in another embodiment, if one of the first or second HEP inverter modules 72, 74 fails, the back-up mode 170 may be configured to replace only the HEP inverter module that failed instead of both.

Referring back to FIGS. 2.1-2.3, the APL inverter module 58 may be configured to back up the first HEP inverter module 72 through switching gear 174, and the traction inverter module 50 for traction motor TM1 may be configured to back up the second inverter module 74 through switching gear 176. However, other configurations may be used to implement back-up mode 170 of the HEP system 48. All of the traction inverter modules 50, the APL inverter module 58, the first HEP inverter module 72, and the second HEP inverter module 74 may be identical to each other. Therefore, in back-up mode 170, the APL inverter module 58 and the traction inverter module 50 for traction motor TM1 may easily take the place of the first HEP inverter module 72 and the second HEP inverter module 74, respectively.

Through switching gear 178, all of the APL loads 56 may be connected to the HEP bus 80 on the output of the HEP transformer 78 in back-up mode 170. Furthermore, in back-up mode 170, traction motor TM1 may be cut-out of the traction system 42, which may operate with only three traction motors 52. In order to enter into the back-up mode 170, operator interface 110 (FIG. 5) may include a switch 180 (FIG. 5), or other type of operator control. The switch 180 may be configured to receive input from the operator to operate in back-up mode 170 and send a corresponding signal to the control system 106 to enter into back-up mode 170.

Moreover, the control system 106 may be configured to send a signal to the operator interface 110 to notify the operator when one of the first and second HEP inverter modules 72, 74 fails. For example, the FIRE display 116 may display a message to the operator indicating HEP inverter failure. The operator may then manually decide to enter into back-up mode 170 via switch 180. In one example, the control system 106 may enter into back-up mode 170 automatically when one of the first or second HEP inverter modules 72, 74 fails.

The power system 30 of the locomotive 22 may also include over voltage protection levels for the traction inverter modules 50, the APL inverter module 58, the first HEP inverter module 72, and the second HEP inverter module 74. For example, in a first protection level, the control system 106 may stop controlling gates of the inverter modules 50, 58, 72, 74 when voltage on the DC link 38, 40 reaches a predetermined threshold. In a second protection level, the power system 30 may include an over voltage crowbar rectifier (OVCRf) system 182 (FIG. 2.1) configured to protect all of the inverter modules 50, 58, 72, 74 from failure due to over voltage. For instance, the OVCRf system 182 may include crowbar circuits 184 (FIG. 2.1) configured to short positive and negative buses of the DC link 38, 40 and dissipate all the energy through a resistor. When either of the first or second protection levels occur, the control system 106 may then send the signal to the operator interface 110 to notify the operator of inverter failure.

### INDUSTRIAL APPLICABILITY

In general, the foregoing disclosure finds utility in various industrial applications, such as, in transportation, mining, earthmoving, construction, industrial, agricultural, and forestry vehicles and machines. In particular, the disclosed load management system may be applied to trains, locomotives, mining vehicles, on-highway vehicles, earth-moving vehicles, loaders, excavators, dozers, motor graders, tractors, trucks, backhoes, agricultural equipment, material handling equipment, marine vessels, and the like. By applying the disclosed systems to a locomotive, head end power (HEP) is supplied to railcars in an efficient, robust, and cost-effective way. In particular, the disclosed HEP system provides power through parallel inverters connected by a transformer. In so doing, the disclosed HEP system does not require a separate HEP generator, thereby reducing noise levels, fuel consumption, and emission levels in the locomotive.

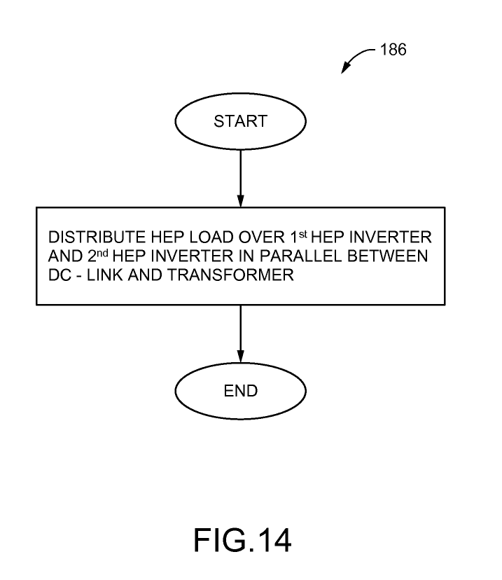

Turning now to FIG. 14, with continued reference to FIGS. 1-13, a flowchart illustrating an example process 186 for providing head end power (HEP) in a locomotive is shown, according to another embodiment of the present disclosure. The process 186 may comprise distributing a HEP load over a first HEP inverter module and a second HEP inverter module in parallel between a direct current (DC) link and a transformer. It is to be understood that the flowchart in FIG. 14 is shown and described as an example only to assist in disclosing the features of the disclosed system, and that more steps than that shown may be included in the method corresponding to the various features described above for the disclosed system without departing from the scope of the disclosure.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto. Moreover, while some features are described in conjunction with certain specific embodiments, these features are not limited to use with only the embodiment with which they are described, but instead may be used together with or separate from, other features disclosed in conjunction with alternate embodiments.

What is claimed is:

1. A head end power (HEP) system for a locomotive, the HEP system comprising:
a first HEP inverter module operatively connected between a direct current (DC) link and a transformer; and
a second HEP inverter module operatively connected between the DC link and the transformer in parallel with the first HEP inverter module, the first HEP inverter module and the second HEP inverter module configured to convert power from the DC link into an alternating current (AC), the transformer configured to transfer power from the first HEP inverter module and the second HEP inverter module to a HEP bus.

2. The HEP system of claim 1, wherein the transformer comprises a dual primary winding delta-delta-wye three-phase transformer.

3. The HEP system of claim 2, further comprising a first line filter module connected between the first HEP inverter module and the transformer, and a second line filter module connected between the second HEP inverter module and the transformer, each of the first line filter module and the second line filter module configured to reduce harmonic content on an output of the first HEP inverter module and an output of the second HEP inverter module, respectively.

4. The HEP system of claim 3, further comprising a control system in communication with the first HEP inverter module and the second HEP inverter module, the control system configured to synchronize the second HEP inverter module to the first HEP inverter module using phase lock loop.

5. The HEP system of claim 4, wherein the control system includes a first HEP inverter controller in communication with the first HEP inverter module, a second HEP inverter controller in communication with the second HEP inverter module and the first HEP inverter controller, and a locomotive control computer (LCC) in communication with the first HEP inverter controller and the second HEP inverter controller.

6. The HEP system of claim 5, wherein the control system may be configured to implement sine-triangle pulse width modulation (PWM) with a third order harmonic injection when controlling the first HEP inverter module and the second HEP inverter module.

7. The HEP system of claim 6, wherein the control system is configured to interleave carrier waveforms on the first HEP inverter module and the second HEP inverter module, and implement a carrier phase shift of 180 degrees.

8. The HEP system of claim 7, further comprising an auxiliary power locomotive (APL) inverter module configured to back up the first HEP inverter module in a back-up mode.

9. The HEP system of claim 8, further comprising a traction inverter module configured to back up the second HEP inverter module in the back-up mode.

10. The HEP system of claim 9, further comprising an operator interface in communication with the control system, the operator interface configured to receive input from and output data to an operator of the locomotive, the control system configured to send a signal to the operator interface to notify the operator when one of the first HEP inverter module and the second HEP inverter module fails.

11. The HEP system of claim 10, wherein the operator interface includes a switch configured to receive input from the operator to operate in the back-up mode, and send a corresponding signal to the control system to enter into the back-up mode.

12. A locomotive, comprising:
a power source;
a fraction system operatively connected to the power source and configured to move the locomotive;
an auxiliary power locomotive (APL) system operatively connected to the power source and configured to provide power to auxiliary loads of the locomotive; and
a head end power (HEP) system operatively connected to the power source and configured to provide power through a HEP bus to passenger cars of the locomotive, the HEP system including:
a transformer including a first primary winding and a second primary winding, the transformer configured to transfer power to the HEP bus;
a first HEP inverter module operatively connected between a direct current (DC) link and the first primary winding of the transformer; and
a second HEP inverter module operatively connected between the DC link and the second primary winding of the transformer, the second HEP inverter module in parallel with the first HEP inverter module, the first HEP inverter module and the second HEP inverter module configured to convert power from the DC link into an alternating current (AC) for the HEP bus.

13. The locomotive of claim 12, wherein the HEP system further includes:
a first line filter module connected between the first HEP inverter module and the first primary winding of the transformer, and
a second line filter module connected between the second HEP inverter module and the second primary winding of the transformer, each of the first line filter module and the second line filter module configured to reduce harmonic content on an output of the first HEP inverter module and an output of the second HEP inverter module, respectively.

14. The locomotive of claim 13, wherein the APL system includes an APL inverter module configured to convert power from the DC link into AC for loads of the APL system, the APL inverter module selectively connected to back up the first HEP inverter module in case one of the first HEP inverter module and the second HEP inverter module fails.

15. The locomotive of claim 14, wherein the traction system includes a traction inverter module configured to convert power from the DC link into AC for a traction motor of the traction system, the traction inverter module selectively connected to back up the second HEP inverter module in case one of the first HEP inverter module and the second HEP inverter module fails.

16. The locomotive of claim 15, wherein the first HEP inverter module, the second HEP inverter module, the APL inverter module, and the traction inverter module are identical.

17. The locomotive of claim 13, further comprising an over voltage crowbar rectifier (OVCRf) system configured to protect each of the first HEP inverter module, the second HEP inverter module, the APL inverter module, and the traction inverter module from failure due to over voltage.

18. The locomotive of claim 13, further comprising a dynamic braking (DB) grid chopper system operatively connected to the traction system, the APL system, and the HEP system, the DB grid chopper system configured to generate power through DB of the traction motor in the traction system for use by the APL system and the HEP system.

19. A method for providing head end power (HEP) in a locomotive, the method comprising:
distributing a HEP load over a first HEP inverter module and a second HEP inverter module in parallel between a direct current (DC) link and a transformer.

20. The method of claim 19, further comprising the transformer receiving alternating current from the first HEP inverter module on a first primary winding and alternating current from the second HEP inverter module on a second primary winding.
